(19) United States
(12) Patent Application Publication
(10) Pub. No.: US 2003/0066059 A1
(43) Pub. Date: Apr. 3, 2003

(54) Method for executing java application midlet using communication among java applications

(75) Inventors: Bo-hee Moon, Goyang-si (KR); Sung-chan Lee, Seoul (KR); Young-hoo Lee, Seongnam-si (KR)

Correspondence Address: SUGHRUE MION, PLLC, 2100 Pennsylvania Avenue, NW, Washington, DC, 20037-3213, US

(73) Assignee: SAMSUNG ELECTRONICS CO., LTD.

(21) Appl. No.: 10/189,763

(22) Filed: Jul. 8, 2002

(30) Foreign Application Priority Data
Jul. 7, 2001 (KR) 2001-40683

(51) Int. Cl. G06F 9/45

(52) U.S. Cl. 717/148

(57) ABSTRACT

A method for executing a Java application midlet using communication among Java applications is provided. The method includes storing information about a predetermined Java application; receiving the name of an object or the name of a mathematical function from a Java application downloaded through a wireless network and retrieving an object or mathematical function corresponding to the received name; and providing the object or the mathematical function to the downloaded Java application to execute the downloaded Java application. Accordingly, support of mathematical functions can be accomplished among Java objects, one Java object can call another Java object, and the amount of data downloaded from a web server and downloading time can be reduced.

### BACKGROUND OF THE INVENTION

1. Field of the Invention

The present invention relates to a method for executing a program downloaded through a wireless network, and more particularly, to a method for allowing the functions of Java applications, which are downloaded in advance, or the functions of Java applications, which are provided from a system, to be used through communication among the Java applications so that the load of a network can be reduced and the Java applications can efficiently execute many functions.

2. Description of the Related Art

As for Java performed in an embedded environment according to conventional technology, a Connected Limited Device Configuration (CLDC) or a Mobile Information Device Profile (MLDP) is built on a level such as the level of an operating system (OS) or a device driver, a Java Application Manager (JAM) is driven on the CLDC or MIDP to download a Java application midlet in the form of a JAR file from a web server, and the Java application midlet is executed. In addition, a Java object in one JAR file is not allowed to access a Java object in another JAR file and is made to have a minimum function so that a function supported by a Java object cannot be understood and the function of one Java object cannot be used by another Java object.

### SUMMARY OF THE INVENTION

To solve the above-described problems, it is a first object of the present invention to provide a method for executing a Java application using communication among Java applications.

It is a second object of the present invention to provide a computer readable recording medium on which a program for executing the above method in a computer is stored.

To achieve the objects of the invention, there is provided a method for executing a Java application midlet using communication among Java applications is provided. The method includes storing information about a predetermined Java application; receiving the name of an object or the name of a mathematical function from a Java application downloaded through a wireless network and retrieving an object or mathematical function corresponding to the received name; and providing the object or the mathematical function to the downloaded Java application to execute the downloaded Java application.

### BRIEF DESCRIPTION OF THE DRAWINGS

The above objects and advantages of the present invention will become more apparent by describing in detail a preferred embodiment thereof with reference to the attached drawings in which:

FIG. 1 is a flowchart of a method for executing a Java application using communication among Java applications according to the present invention;

FIG. 2 is a flowchart of an embodiment using communication among Java applications according to the present invention; and

FIG. 3 is a diagram of the hierarchical architecture of a Java program performed in an embedded environment according to the present invention.

### DETAILED DESCRIPTION OF THE INVENTION

Hereinafter, an embodiment of the present invention will be described in detail with reference to the attached drawings.

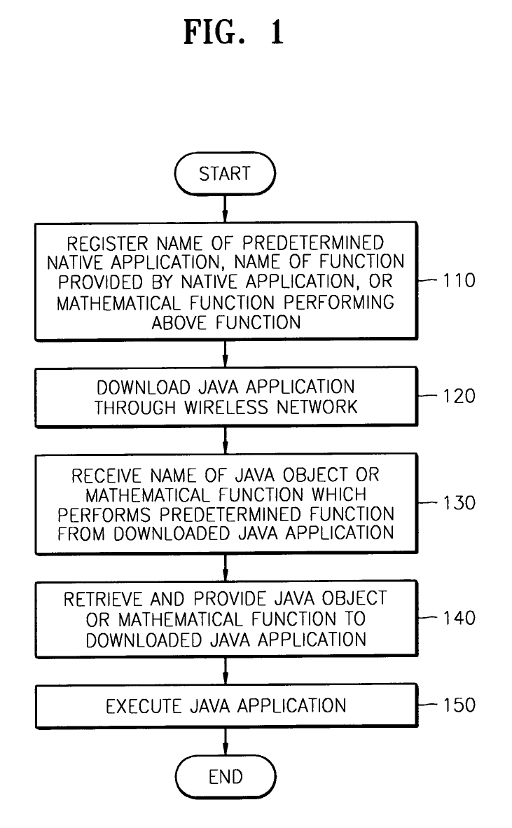

Referring to FIG. 1, the name of a native application such as a browser, a phonebook, an email program or a scheduler, which is installed in a portable terminal and provides a function to a Java application downloaded through a wireless network, the name of the function to be provided, or a mathematical function which can perform the function is registered in an Original Equipment Manufacture System (OEMSys) in step 110. The OEMSys is on a level having a function of managing a Java application performed on a Java based platform. In other words, the OEMSys informs what system applications are provided on the platform, can detect whether a particular application is registered therein using the name of the application, and stores or obtains the values of variables that should be permanently stored in the platform. More specifically, step 110 is performed using a hash table as follows. The name of an application to be stored is registered as a key, and an application object is registered as a value. The name of a function of an application may be registered as a key, and an application object may be registered as a value. The name of a function to be provided may be registered as a key, and a mathematical function providing the function may be registered as a value.

In step 120, a Java application is downloaded through the wireless network using the portable terminal. In step 130, the OEMSys receives the name of a Java object or mathematical function, which performs a predetermined function, from the downloaded Java application. In step 140, the OEMSys retrieves a Java object or mathematical function corresponding to the received name from the hash table and provides it to the downloaded Java application. In step 150, the downloaded Java application is executed so that the portable terminal can be provided with a web service or access an Internet site.

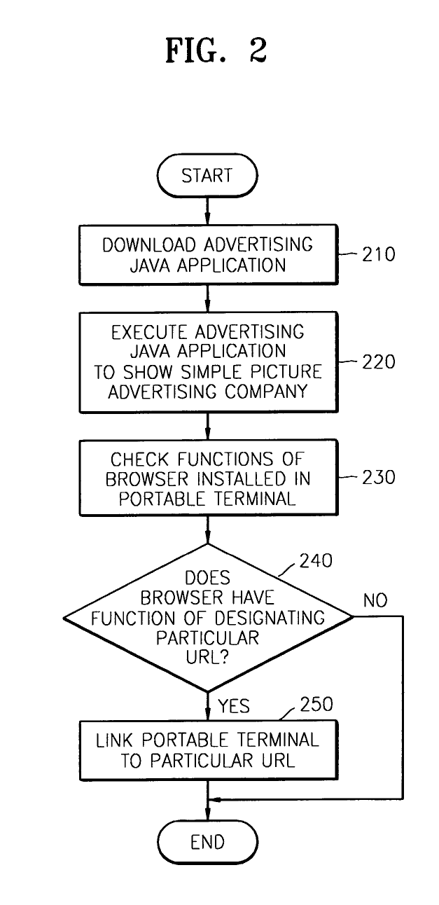

FIG. 2 is a flowchart of an embodiment using communication among Java applications according to the present invention. In FIG. 2, a particular advertising Java application is downloaded and a portable terminal is linked to a particular Uniform Resource Locator (URL).

In step 210, a user downloads an advertising Java application of a particular company or a particular Internet site using a portable terminal (for example, a portable telephone, PDA or mobile terminal). In step 220, the advertising Java application is executed to show a simple picture advertising the particular company or Internet site. In step 230, If a mathematical function for designating the URL of the company or Internet site is not programmed in the downloaded Java application, the functions of a browser installed in an OEMSys are checked. If it is determined that the browser has a function of designating a particular URL in step 240, the portable terminal is linked to the particular URL through the browser in step 250. In contrast, if it is determined that the browser does not have a function of designating a particular URL in step 240, the downloaded application is terminated. With such a method, time taken for a user to download a Java application using a portable terminal can be reduced.

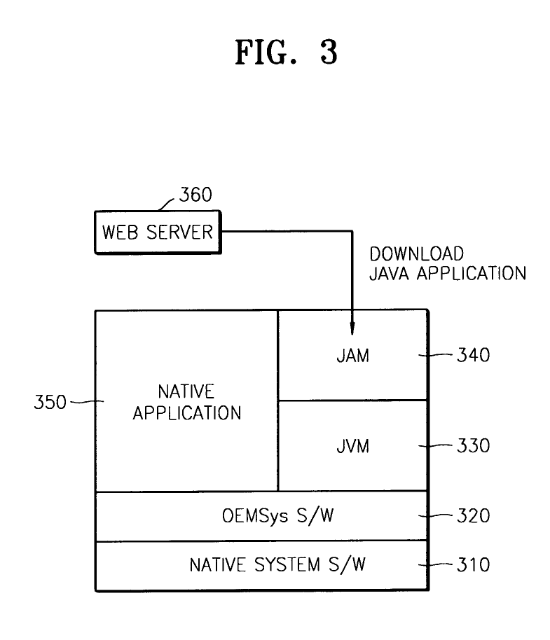

FIG. 3 is a diagram of the hierarchical architecture of a Java program performed in an embedded environment according to the present invention. Native system software (S/W) (native system application) 310 denotes an operating system or a device drive. OEMSys S/W 320 receives the name of a mathematical function from a downloaded Java application and retrieves a mathematical function corresponding to the name to provide the mathematical function to the downloaded Java application. The OEMSys S/W 320 stores information including the name or a function of a native application 350, the name of the function, or a mathematical function performing the function. The native application 350 may be a browser, phonebook, email program or scheduler. A Java Virtual Machine (JVM) 330 analyzes and executes a Java source. A Java Application Manager (JAM) 340 executes a Java application downloaded from a web server 360.

The present invention can be realized as a code which is recorded on a computer readable recording medium and can be read by a computer. The computer readable recording medium may be any type on which data which can be read by a computer system can be recorded, for example, a ROM, a RAM, a CD-ROM, a magnetic tape, a hard disc, a floppy disc, a flash memory, or an optical data storage device. The present invention can also be realized as carrier waves (for example, transmitted through Internet). Alternatively, computer readable recording media are distributed among computer systems connected through a network so that the present invention can be realized as a code which is stored in the recording media and can be read and executed in the computers.

As described above, according to the present invention, a Java application downloaded through wireless communication can use the mathematical function of a native application (for example, a browser, email, scheduler or phonebook) because the native application performed in an embedded environment is embodied in Java when a Java based platform is formed. Therefore, the size of a Java application can be reduced, and the size of downloaded data can be reduced.

What is claimed is:

1. A method for executing a Java application midlet using communication among Java applications, the method comprising the steps of:
(a) storing information about a predetermined Java application;
(b) receiving the name of an object or the name of a mathematical function from a Java application downloaded through a wireless network and retrieving an object or mathematical function corresponding to the received name; and
(c) providing the object or the mathematical function to the downloaded Java application to execute the downloaded Java application.

2. The method of claim 1, wherein step (a) comprises storing a name of a native application, a name of a function provided by the native application, or a mathematical function performing the function.

3. The method of claim 2, wherein the downloaded Java application in step (b) needs at least one mathematical function included in the native application.

4. The method of claim 1, wherein step (b) comprises receiving at least one among the name of an object, a function performed by a mathematical function, or the name of the mathematical function, from the downloaded Java application, retrieving an object or mathematical function corresponding to the received name, and providing the object or mathematical function to the downloaded Java application.

5. A recording medium on which a program for performing the method of any one of claims 1 through 4 in a computer is recorded, the recording medium being able to be read by the computer.
